(19) United States
(12) Patent Application Publication
(10) Pub. No.: US 2005/0010507 A1
(43) Pub. Date: Jan. 13, 2005

(54) Device and method for financial services contact management

(76) Inventor: Russell Straub, Evergreen, CO (US)

Correspondence Address: The Law Office of Craig W. Barber, PO Box 16220, Golden, CO, 80402-6004, US

(21) Appl. No.: 10/618,215

(22) Filed: Jul. 11, 2003

(51) Int. Cl. G06F 17/60

(52) U.S. Cl. 705/35

(57) ABSTRACT

The present invention teaches that financial services, in particular mortgage lending/brokerage services may be offered on-line via a consumer contact management system which impels faster responses on the part of mortgage professionals. In particular, when a consumer provides a contact to a financial professional, the information provided is mediated by a central computer system/server/site and divided into specific contact information (such as name, E-mail address, telephone number, etc) and general financial information (such as loan amount, property value, credit history, age, income, etc). The central system then forwards the general financial information to the financial professional but withholds the specific contact information until the professional responds (by way of the same system), at which time specific contact information is provided. Statistics on response effectiveness by any one professional may also be maintained by this device.

### FIELD OF THE INVENTION

This invention relates generally to contact management software and specifically to management of contacts for financial services.

### STATEMENT REGARDING FEDERALLY FUNDED RESEARCH

This invention was not made under contract with an agency of the US Government, nor by any agency of the US Government.

### BACKGROUND OF THE INVENTION

Increasingly, financial services are being offered on the Internet. One particular example of such service offerings is that of mortgage brokers and lenders whose rates and services may be found compared at various well known websites. In general, a consumer logs onto such a website, provides some information, and either automatically or manually attempts to contact mortgage lenders, makers or brokers.

However, while the automated portion of the system can be very prompt at providing information and feed back to the consumer, this system may lag when the human financial professional enters the picture. The financial professional may be very busy, may be irregular about checking E-mail, may have poor Internet access and so on. Thus in a large organization with many mortgage brokers, lenders, or other financial professionals, there may be certain individuals who are extremely efficient about answering their E-mail or other contacts from consumers and others who are less efficient. Tracking the performance of the group as a whole, and the individuals within the group, is thus a high priority.

In addition, it is important that the financial professionals be impelled to respond promptly when contacted.

Various method may be tried for offering of on-line financial services.

U.S. Pat. No. 6,428,526 issued Aug. 20, 2002 to Dykes et al for SYSTEM AND METHOD FOR TRANSMITTING AND PROCESSING LOAN DATA teaches an Internet based system in which brokers and correspondents may exchange information by means of a website. In communications between brokers and a server, some sort of file structure is used. It appears that this patent does not specifically mention a controlled usage of E-mail in which the broker must respond via server before receiving complete client information.

U.S. Pat. No. 6,405,181 issued Jun. 11, 2002 to Lent et al for METHOD AND APPARATUS FOR REAL TIME ON LINE CREDIT APPROVAL teaches use of a computer system to request and analyze FICO scores. The only area of potential relevance is FIG. 14, showing that the Internet may be used by the server to obtain client information. Thus this patent also does not mention the use of the server to require, manage and monitor broker communications.

U.S. Pat. No. 6,385,594 issued May 7, 2002 to Lebda et al for METHOD AND COMPUTER NETWORK FOR CO-ORDINATING A LOAN OVER THE INTERNET teaches that a central computer 100 may be used to control loan application data transmitted over the Internet, however, limiting contact data of potential clients so as to require prompt response by mortgage brokers is not mentioned.

U.S. Pat. No. 6,345,262 issued Feb. 5, 2002 to Madden for SYSTEM AND METHOD FOR IMPLEMENTING A MORTGAGE PLAN teaches an automated method for creation of a mortgage plan, and thus is of little relevance to the present invention.

U.S. Pat. No. 6,272,528 issued Aug. 7, 2001 to Cullen et al for COMPUTER METHOD FOR DELIVERY OF FINANCIAL SERVICES teaches the use of mobile client-side agents to deliver financial quotes and other information to users. There seems to be no intermediary between ‘contacts’ and brokers and thus few if any structural similarities with the present invention.

U.S. Pat. No. 5,995,947 issued Nov. 30, 1999 to Fraser et al for INTERACTIVE MORTGAGE AND LOAN INFORMATION AND REAL-TIME TRADING SYSTEM teaches another method similar to that of the '594 patent above, which method of trading mortgage application information utilizes a transaction server 110. However, there is no discussion of control of ‘contacts’ so as to impel prompt broker response.

U.S. Pat. No. 5,983,206 issued Nov. 9, 1999 to Oppenheimer for COMPUTER SYSTEM AND COMPUTER-IMPLEMENTED PROCESS FOR IMPLEMENTING A MORTGAGE PARTNERSHIP teaches another method similar to the '262 patent above, dealing with automated structuring of mortgage documents, and thus again having little structural or conceptual similarity to the present invention.

U.S. Pat. No. 5,940,812 issued Aug. 17, 1999 to Tengel et al for APPARATUS AND METHOD FOR AUTOMATICALLY MATCHING BEST AVAILABLE LOAN TO A POTENTIAL BORROWER VIA GLOBAL TELECOMMUNICATIONS NETWORK teaches a matching method allowing matching of consumers and lenders via the Internet, however, it deals with loan origination and sends complete consumer information and thus does not teach central features of the present invention in a manner similar to the '206 and '262 patents above.

U.S. Pat. No. 5,231,571 issued Jul. 27, 1993 to D'Agostino for PERSONAL FINANCIAL ASSISTANT COMPUTER METHOD teaches a network of computers in which one terminal is used by a consumer but controlled by a remote financial representative at a remote representative terminal. The structure of the method is very different from the structure of the present invention.

It would be advantageous to mediate between the consumer and the professional at the first contact, both in order to impel faster response by the professional and in order to gather statistics regarding speed and efficiency of the professional.

### SUMMARY OF THE INVENTION

General Summary

The present invention, however, does not make a direct contact between an interested consumer and a mortgage professional they contact. Instead, after viewing the website geared to consumers, the consumer sends an email or otherwise notifies the site/server/central computer system of interest in a given financial/mortgage/real estate professional. The server emails the financial/real estate/mortgage professional with an email which does NOT contain any contact information for the consumer; instead the email is actually a link to the server's website geared to professionals. Once there, the professional responds to the consumer and receives direct consumer contact information such as telephone number, email address, etc. This server-based system not only impels professionals to make a prompt first response in order to secure the contact information, it also allows supervisory personnel to keep statistics on professional response time, consumer behavior, etc.

Thus, the present invention teaches that financial services, in particular mortgage lending/brokerage services may be offered on-line via a consumer contact management system which impels faster responses on the part of mortgage professionals. In particular, when a consumer provides a contact to a financial professional, the information provided is mediated by a central computer system/server/site and divided into specific contact information (such as name, E-mail address, telephone number, etc) and general financial information (such as loan amount, purchase price, property value, credit history, age, income, etc). The central system then forwards the general financial information to the financial professional but withholds the specific contact information until the professional responds (by way of the same system), at which time specific contact information is provided. Statistics on response effectiveness by any one professional may also be maintained by this device.

### SUMMARY IN REFERENCE TO CLAIMS

It is therefore a first aspect, advantage, objective and embodiment of the present invention to provide a financial services consumer contact management device comprising: a first computer network site oriented to consumers and offering the services of financial service professionals; a first communication connection allowing consumers to provide to the first site a consumer contact for a financial service professional, the consumer contact consisting of specific contact information and general financial information, a receiving module able to receive a consumer contact, separate the specific contact information and the general financial information, and forward the general financial information to the financial service professional; a second communication connection allowing the financial service professional to provide to the first site a response to the forwarding of the consumer contact; a monitoring module able to receive the response, and forward the specific contact information to the financial professional.

It is therefore another aspect, advantage, objective and embodiment of the present invention to provide a device wherein the first computer network site further comprises an Internet website maintained on a server computer.

It is therefore yet another aspect, advantage, objective and embodiment of the present invention to provide a device wherein the specific contact information comprises at least one member selected from the group consisting of: name, address, telephone number, facsimile number, E-mail address, website address, instant messenger name and combinations thereof.

It is therefore yet another aspect, advantage, objective and embodiment of the present invention to provide a device wherein the general financial information comprises at least one member selected from the group consisting of: loan amount, purchase price, property value, loan type, credit history, assets, liabilities, income, employment, age, marital status, rental history, property ownership, net worth, and combinations thereof.

It is therefore yet another aspect, advantage, objective and embodiment of the present invention to provide a device wherein the first communication connection comprises one member selected from the group consisting of: E-mail, telephone, facsimile, SMS, mail, web page, web address, Internet postings, computer chat, and combinations thereof.

It is therefore yet another aspect, advantage, objective and embodiment of the present invention to provide a device further comprising: a professional management module able to maintain a database of contact statistics.

It is therefore yet another aspect, advantage, objective and embodiment of the present invention to provide a device wherein such database of contact statistics further comprises data selected from the group consisting of: contact demographics, contact method, method of offering services responded to, contact financial information, specific contact information, response content, response time, financial service professional identity and combinations thereof.

It is therefore yet another aspect, advantage, objective and embodiment of the present invention to provide a device wherein the response to the forwarding of the consumer contact comprises one member selected from the group consisting of: a communication from the professional to the consumer, an indication that the first communication has been received, an indication of the status of the contact, and combinations thereof.

It is therefore yet another aspect, advantage, objective and embodiment of the present invention to provide a device wherein the monitoring module further comprises a sub-module able to forwarding the professional's response to the consumer contact to the consumer.

It is therefore yet another aspect, advantage, objective and embodiment of the present invention to provide a method for financial service professionals to manage consumer contacts, comprising the steps of: a) offering a first computer network site offering the services of such financial professionals to consumers, such site offering consumers the ability to generate a consumer contact for such financial service professionals; b) receiving the consumer contact from such a consumer on behalf of financial service professionals, the consumer contact comprising both specific contact information and general financial inquiry information; c) separating the specific contact information from the general financial inquiry information; d) forwarding to such financial service professional the general financial inquiry information; e) awaiting a confirmation that such financial service professional has responded to such consumer contact; and f) after the confirmation, forwarding to such financial service professional the specific contact information.

It is therefore yet another aspect, advantage, objective and embodiment of the present invention to provide a method wherein the step e) of awaiting a confirmation that such financial service professional has responded to such contact further comprises: e1) providing to such financial service professional the ability to respond to such contact; e2) receiving from such financial service professional such response; and e3) forwarding such response to the consumer.

It is therefore yet another aspect, advantage, objective and embodiment of the present invention to provide a method further comprising: g) maintaining a database of contact statistics.

It is therefore yet another aspect, advantage, objective and embodiment of the present invention to provide a method wherein such database of contact statistics further comprises data selected from the group consisting of: contact demographics, contact method, method of offering services responded to, contact financial information, specific contact information, response content, response time, financial service professional identity and combinations thereof.

It is therefore yet another aspect, advantage, objective and embodiment of the present invention to provide a method and system for tracking and managing contacts between consumers and financial services professionals, the method comprising the computer-implemented steps of: a) receiving a contact consisting of specific consumer contact information and general financial information; b) separating the specific contact information and the general financial information; c) forwarding the general financial information to the financial service professional; d) monitoring an action taken by the financial service professional; prior to e) forwarding the specific contact information to the financial professional.

It is therefore yet another aspect, advantage, objective and embodiment of the present invention to provide a method wherein the step of receiving the specific consumer contact information and general financial information further comprises one member selected from the group consisting of: receiving the consumer contact information and financial information manually via telephone, receiving the consumer contact information and financial information via E-mail, receiving the consumer contact information and financial information from a financial professional supervisory individual, receiving the consumer contact information and financial information from a second financial professional, receiving the consumer contact information and financial information via facsimile, receiving the consumer contact information and financial information via SMS, receiving the consumer contact information and financial information via mail, receiving the consumer contact information and financial information via web page, receiving the consumer contact information and financial information via web address, receiving the consumer contact information and financial information via Internet postings, receiving the consumer contact information and financial information via computer chat, and combinations thereof.

### BRIEF DESCRIPTION OF THE DRAWINGS

FIG. 1 is a block diagram of a first device embodiment of the present invention.

FIG. 2 is a block diagram of a second device embodiment of the present invention.

FIG. 3 is a flow chart of a third method embodiment of the present invention.

### INDEX OF REFERENCE NUMERALS

| | |
|---|---|
| DEVICE | 100 |
| CONSUMER COMPUTER | 102 |
| CONSUMER ORIENTED SERVER SITE | 104 |
| FINANCIAL PROFESSIONAL COMPUTER | 106 |
| FINANCIAL PROFESSIONAL SERVER SITE | 108 |
| NETWORK | 110 |
| CONSUMER CONNECTION TO NETWORK | 112 |
| PROFESSIONAL CONNECTION | 114 |
| FINANCIAL PRO SERVER CONNECTION | 116 |
| SERVER TO SERVER CONNECTION | 120 |
| DEVICE | 200 |
| FINANCIAL PROFESSIONAL COMPUTER | 206 |
| FINANCIAL PROFESSIONAL SITE | 208 |
| NETWORK | 210 |
| PSTN/POTS TELEPHONE SERVICE | 212 |
| FACSIMILE SERVICE | 214 |
| SHORT MESSAGE SERVICE | 216 |
| METHOD | 300 |
| START | 330 |
| CONSUMER INQUIRY | 332 |
| SEPARATE STORAGE OF | 334 |
| CONTACT AND FINANCIAL DATA | |
| FORWARD FINANCIAL DATA TO | 336 |
| FINANCIAL PRO | |
| WAIT | 338 |
| FINANCIAL PRO RESPONSE CHECK | 340 |
| FORWARD RESPONSE TO CONSUMER | 342 |
| FORWARD CONTACT INFORMATION TO | 344 |
| FINANCIAL PROFESSIONAL | |
| TERMINATE | 346 |

### DETAILED DESCRIPTION

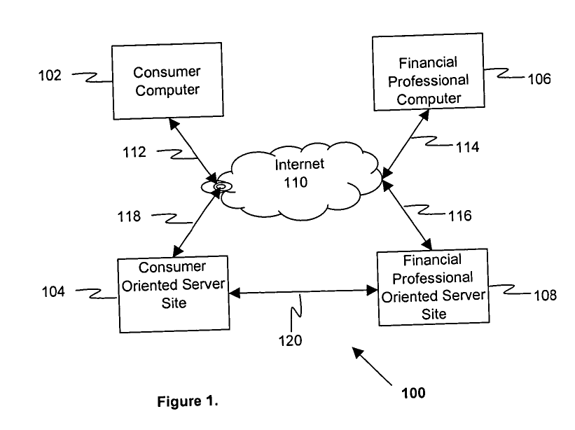

FIG. 1 is a block diagram of a first device embodiment of the present invention. DEVICE 100 links CONSUMER COMPUTER 102 with CONSUMER ORIENTED SERVER SITE 104. FINANCIAL PROFESSIONAL COMPUTER 106 is linked to FINANCIAL PROFESSIONAL SERVER SITE 108. Both linkages occur via NETWORK 110, which in the preferred embodiments is the Internet. In other embodiments, other computer networks may be utilized. CONSUMER CONNECTION TO NETWORK 112, PROFESSIONAL CONNECTION 114, FINANCIAL PRO SERVER CONNECTION 116, and CONSUMER SERVER CONNECTION 120 may be effectuated by any of a variety of methods. In a case in which network 110 is the Internet, such connections may be dial-up, cable, DSL, T1, wireless, etc, and may be provided through an ISP or other conventional methods.

Servers/Sites 104 and 108 may be one or more websites offered by means of the Internet (as in the best mode now contemplated), or may be another type of computer provided intermediary. In general, the important component is a central computer system which provides communications links between consumers and professionals, which offers/advertises financial services to consumers, and which stores and forwards information according to the present device. Thus, this may be a central computer system, a single website, a pair of websites, a dedicated network in hardware or software, etc. Servers/Sites 108 and 104 may be combined into a single entity which provides differential access to professionals versus consumers. Thus two websites or one may be offered, or two servers or one may be utilized.

When more than one such entity is used (as shown in FIG. 1), then SERVER TO SERVER CONNECTION 120 may provide a connection from sites/servers 104 and 108. In the presently preferred embodiment and best mode presently contemplated for carrying out the invention, the need for connection 120 is obviated by making the site to site connection (104 to 108) be means of the Internet. Thus, in embodiments connection 120 may or may not be necessary or desirable even in cases in which two or more central computer systems/servers/sites are utilized.

Consumer computer 102 is used to access the information provided at consumer oriented server site 104. In one embodiment, this information may be comparative statistics regarding financial services offered by different lenders, banks, mortgage brokers, investment bankers and brokers, and so on. Side by side comparison of details of such offers has proven beneficial to the consumer. Thereafter, the consumer may initiate a consumer contact with selected financial professionals. Such contacts may also be initiated automatically by consumer usage of features of site 104, for example, by the consumer electing to examine a repayment schedule for a given mortgage at a given percentage rate and time.

The communication connections provided to consumers and professionals may be E-mail, telephone, facsimile, short message service (text message) (SMS), mail, Internet postings, a web page form, computer chat and combinations thereof. For example, the consumer may be asked to fill out a form on-line, providing information in blanks on a web page. This information may then be submitted to the central computer.

One important module of the present device is a receiving module able to receive such consumer contacts as an intermediary between the consumer and the professional. The module will separate the specific contact information from the general financial information and forward only the general financial inquiry information to the financial service professional.

The financial service professional will also have a connection, which may be the same or a different type, for communicating a response to the consumer. Since the professional has received no specific contact information, the intermediary site(s) are necessary for this return communication. In one preferred embodiment, the consumer may use a web form or E-mail for the first communication connection, but the professional will actually have a choice of types of communication connections, so that the use of the device by the professional may be customized to suit their own needs.

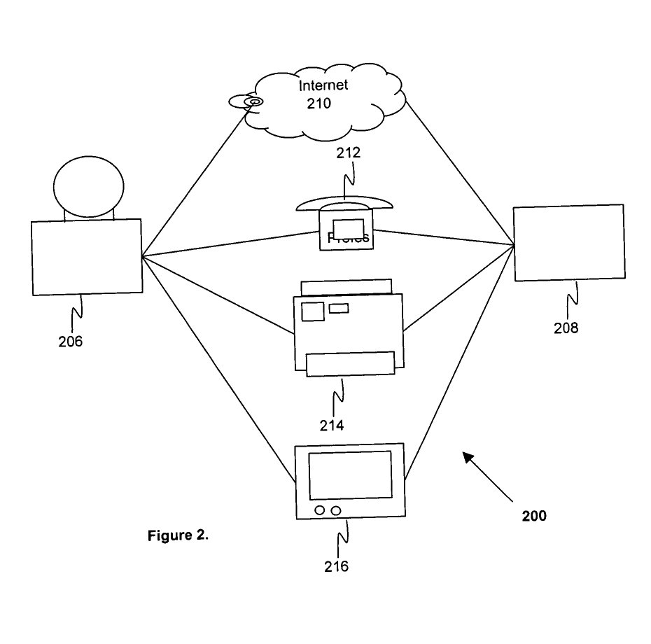

FIG. 2 is a block diagram of a second device embodiment of the present invention. DEVICE 200 is depicted in part: FINANCIAL PROFESSIONAL COMPUTER 206 and FINANCIAL PROFESSIONAL SITE 208 are shown communicating by any of a variety of means. As previously shown in FIG. 1, NETWORK 210 (in particular, the Internet) may be used, for example by sending an E-mail, a page link, a chat message, etc. However, PSTN/POTS TELEPHONE SERVICE 212 (or equivalent, for example VoIP (Voice over Internet Protocol, paging, etc) may be used to send an audio message: this may be a pre-recorded or computer generated signal or voice message. FACSIMILE SERVICE 214 may also be used to send a facsimile message to the professional. SHORT MESSAGE SERVICE 216 may also be used.

While these messages are shown flowing to the financial professional directly, it will be appreciated that for messages sent via Internet postings, E-mail, fax, telephone, Internet chat services, or SMS, there may be an additional intermediary in the form of the financial professional's computer 106 or other devices.

Device 100 may also comprise a monitoring module able to monitor the financial professional for a response to the consumer contact. In the presently preferred embodiment, this may take the form of server/site/central computer system 108: the professional would log onto this server and use it to send a message to the consumer. The device 100 (acting again as intermediary) will retain the specific contact information needed to allow this response to be forwarded to the consumer, as this information has not yet been provided to the professional. Only after the professional has carried out the response will such specific contact information be forward the specific contact information to the financial professional. In alternative embodiments, other structures may be used by which the professional does not receive such specific contact information until completion of some type of response to the contact. In yet further embodiments, the professional response may not be an actual communication with the consumer but may take the form of a “book-keeping” step allowing monitoring of overall professional activities.

In an alternative embodiment, an additional professional management module may be used to monitor contacts and maintain a database of contact statistics. In particular, it will be appreciated that professional performance in responding to consumer contacts is of great importance in any financial service business. As stated earlier, in a large organization with more than one mortgage brokers, lenders, or other financial professionals, there may be certain individuals who are relatively efficient about answering their E-mail or other contacts from consumers and others who are relatively less efficient. Tracking the performance of the group as a whole, and the individuals within the group, is thus a high priority to the organization or group. The present invention allows this tracking by means of a management module. The module may collect information regarding contact demographics such as geographic location, age, income, employment, may retain information regarding contact methods such as E-mail versus text message, method of offering services responded to by the consumer (website, advertising, telephone, etc), contact financial information such as loan type (i.e. purchase, refinance, home equity, etc), credit history, specific contact information as discussed above, response content from the professional, and very importantly: response time, financial service professional identity and combinations thereof. Response time by a given professional allows easy management of the group of professionals and thus increased efficiency of the overall operation.

In the method embodiment of the present invention, the consumer is offered a website or other central location offering the services of the financial professional and offers consumers the ability to generate a consumer contact to the professional.

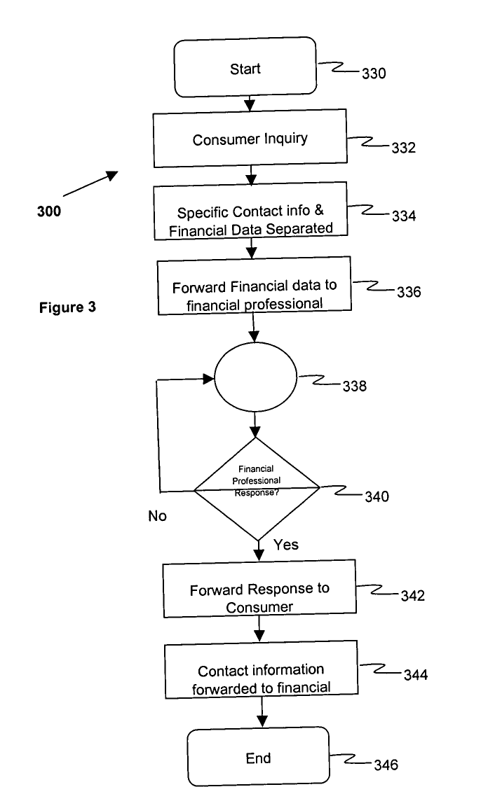

FIG. 3 is a flow chart of a third method embodiment of the present invention. At the start step 330, a consumer makes an inquiry 332 to the professional. The inquiry may contain both specific contact information and general financial inquiry information. At step 334, the two types of data are separated, they may also be stored in a storage medium of the types now know or later developed: magnetic media, optical media, etc. At step 336, the general financial inquiry data is forwarded to the professional. Step 338 represents a wait state: until the condition of step 340 is satisfied, no further activities are undertaken: the system is awaiting a confirmation that such financial service professional has responded to the consumer contact. At step 342 the response is forwarded to the consumer (by means of the specific contact information) and at step 344 the specific contact information is forwarded to the professional. Operations may terminate at step 346 in the preferred embodiment.

The wait at steps 338, 340 may comprise an internal flag, initiation of a response module by the professional response to the consumer, etc, and it may be ended by receipt of any type of communication such as those listed previously for the professional to central system link (see FIG. 2).

In embodiments, the system may also provide to such financial service professional the ability to respond to such contact, for example, by means of a web form in the originally forwarded message, thus greatly easing the burden on the professional to make the response. Other such abilities may be offered to the professional by the service: ability to respond by fax, voice, SMS, E-mail, etc. The system of course is also capable of receiving from such financial service professional such response; and forwarding such response to the consumer.

As a parallel or sequential process to the process outlined above, the system may also maintain a database of contact statistics, as discussed above in reference to the device embodiments of the invention.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

1. A financial services consumer contact management device comprising:
a first computer network site oriented to consumers and offering the services of financial service professionals;
a first communication connection allowing consumers to provide to the first site a consumer contact for a financial service professional, the consumer contact consisting of specific contact information and general financial information;
a receiving module able to receive a consumer contact, separate the specific contact information and the general financial information, and forward the general financial information to the financial service professional;
a second communication connection allowing the financial service professional to provide to the first site a response to the forwarding of the consumer contact;
a monitoring module able to receive the response, and forward the specific contact information to the financial professional.

2. The device of claim 1, wherein the first computer network site further comprises an Internet website maintained on a server computer.

3. The device of claim 1, wherein the specific contact information comprises at least one member selected from the group consisting of: name, address, telephone number, facsimile number, E-mail address, website address, instant messenger name and combinations thereof.

4. The device of claim 1, wherein the general financial information comprises at least one member selected from the group consisting of: loan amount, purchase price, property value, loan type, credit history, assets, liabilities, income, employment, age, marital status, rental history, property ownership, net worth, and combinations thereof.

5. The device of claim 1, wherein the first communication connection comprises one member selected from the group consisting of: E-mail, telephone, facsimile, SMS, mail, web page, web address, Internet postings, computer chat, and combinations thereof.

6. The device of claim 1, further comprising:
a professional management module able to maintain a database of contact statistics.

7. The device of claim 6, wherein such database of contact statistics further comprises data selected from the group consisting of: contact demographics, contact method, method of offering services responded to, contact financial information, specific contact information, response content, response time, financial service professional identity and combinations thereof.

8. The device of claim 1, wherein the response to the forwarding of the consumer contact comprises one member selected from the group consisting of: a communication from the professional to the consumer, an indication that the first communication has been received, an indication of the status of the contact, and combinations thereof.

9. The device of claim 1, wherein the monitoring module further comprises a sub-module able to forwarding the professional's response to the consumer contact to the consumer.

10. A method for financial service professionals to manage consumer contacts, comprising the steps of:
a) offering a first computer network site offering the services of such financial professionals to consumers, such site offering consumers the ability to generate a consumer contact for such financial service professionals;
b) receiving the consumer contact from such a consumer on behalf of financial service professionals, the consumer contact comprising both specific contact information and general financial inquiry information;
c) separating the specific contact information from the general financial inquiry information;
d) forwarding to such financial service professional the general financial inquiry information;
e) awaiting a confirmation that such financial service professional has responded to such consumer contact; and
f) after the confirmation, forwarding to such financial service professional the specific contact information.

11. The method of step 10, wherein the step e) of awaiting a confirmation that such financial service professional has responded to such contact further comprises:
e1) providing to such financial service professional the ability to respond to such contact;
e2) receiving from such financial service professional such response; and
e3) forwarding such response to the consumer.

12. The method of step 10, further comprising:
g) maintaining a database of contact statistics.

13. The method of step 12, wherein such database of contact statistics further comprises data selected from the group consisting of: contact demographics, contact method, method of offering services responded to, contact financial information, specific contact information, response content, response time, financial service professional identity and combinations thereof.

14. A method and system for tracking and managing contacts between consumers and financial services professionals, the method comprising the computer-implemented steps of:
a) receiving a contact consisting of specific consumer contact information and general financial information;
b) separating the specific contact information and the general financial information;
c) forwarding the general financial information to the financial service professional;
d) monitoring an action taken by the financial service professional; prior to
e) forwarding the specific contact information to the financial professional.

15. The method of claim 14, wherein the step of receiving the specific consumer contact information and general financial information further comprises one member selected from the group consisting of: receiving the consumer contact information and financial information manually via telephone, receiving the consumer contact information and financial information via E-mail, receiving the consumer contact information and financial information from a financial professional supervisory individual, receiving the consumer contact information and financial information from a second financial professional, receiving the consumer contact information and financial information via facsimile, receiving the consumer contact information and financial information via SMS, receiving the consumer contact information and financial information via mail, receiving the consumer contact information and financial information via web page, receiving the consumer contact information and financial information via web address, receiving the consumer contact information and financial information via Internet postings, receiving the consumer contact information and financial information via computer chat, and combinations thereof.
